(19) United States
(12) Patent Application Publication
(10) Pub. No.: US 2008/0320318 A1
(43) Pub. Date: Dec. 25, 2008

(54) METHOD AND APPARATUS FOR DATA ENCRYPTION AND DECRYPTION

(75) Inventor: HUNG-CHIH HUANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/052,743

(22) Filed: Mar. 21, 2008

(30) Foreign Application Priority Data
Apr. 12, 2007 (CN) 200710200452.4

(51) Int. Cl. H04L 9/06

(52) U.S. Cl. 713/193; 380/44

(57) ABSTRACT

A method is provided for encrypting data to be stored in a data storage medium. The method includes encrypting the data using a special key associated with the electronic device. One example of the special key is a barcode of the electronic device. The encrypted data then is stored in the data storage medium. When the data stored in the data storage medium is decrypted, only the electronic device has the special key i.e., the barcode, can reproduce the encrypted data. When the data storage medium is lost or stolen, the encrypted data cannot be decrypted by another electronic device because the barcode of current electronic device is different from the original electronic device. Therefore, the encrypted data stored in the data storage medium is prevented from being read out by other electronic devices.

### BACKGROUND

1. Field of the Invention

The present invention generally relates to a method and an apparatus for data encryption and decryption.

2. Description of related art

Data storage medium such as optical disc, flash memory card, solid state disk and so on have been widely used for storing data such as audio, video, photo, etc. In order to prevent unauthorized use or reproduction of the data, the data can be encrypted using a predetermined algorithm and a special key before the data are stored in the data storage medium. The special key is quite important to secure the data, because the data can be decrypted if the special key is known to others.

Conventionally, an identification (ID) number of the data storage medium is used as the special key. When the encrypted data are maliciously copied from an original data storage medium to a second data storage medium, the encrypted data cannot be decrypted because the second data storage medium would have a different ID number with that of the original data storage medium.

However, when the data storage medium is entirely stolen, the encrypted data stored in the data storage medium are readable to other electronic devices, because the ID number is carried with the data storage medium.

Therefore, what is desired is to provide a data encrypting method to safely protect the encrypted data from being read out by different electronic devices, and electronic device employed for encrypting the data.

### SUMMARY

Accordingly, a method is provided for encrypting data to be stored in a data storage medium. The method includes steps of encrypting the data using a special key corresponding to the electronic device. One example of the special key is a barcode of the electronic device. The encrypted data then is stored in the data storage medium. When the data stored in the data storage medium is decrypted, only the electronic device has the special key i.e., the barcode, can reproduce the encrypted data. When the data storage medium is lost or stolen, the encrypted data cannot be decrypted by another electronic device because the barcode of current electronic device is different from the original electronic device. Therefore, the encrypted data stored in the data storage medium is prevented from being read out by other electronic devices. Moreover, an electronic device is employed for encrypting the data.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a functional block diagram of an electronic device according to an exemplary embodiment.

FIG. 2 is a flowchart of data encrypting.

FIG. 3 is a flowchart of data decrypting.

FIG. 4 is another flowchart of data decrypting.

### DETAILED DESCRIPTION

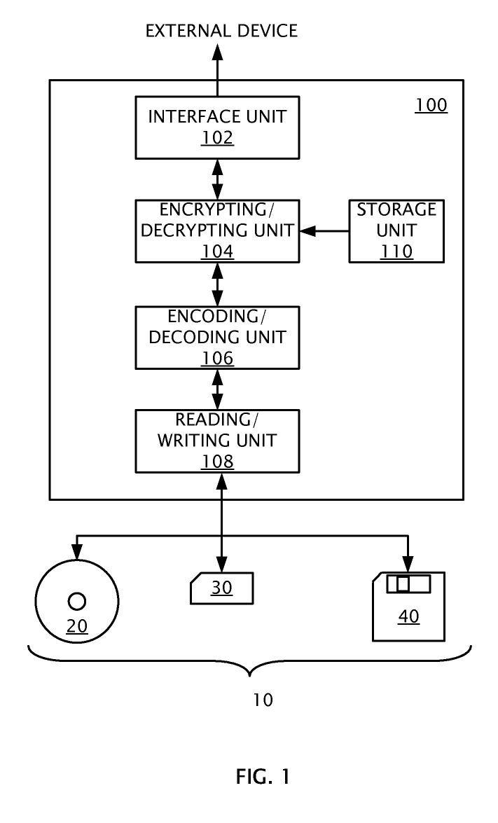

Referring to FIG. 1, a functional block diagram of an electronic device 100 in accordance with an exemplary embodiment is illustrated. The electronic device 100 is used for encrypting data and storing encrypted data in a data storage medium 10 such as an optical disc 20, a flash memory card 30, or a floppy disk 40. The electronic device 100 may include an interface unit 102, an encrypting/decrypting unit 104, an encoding/decoding unit 106, a reading/writing unit 108, and a storage unit 110.

The interface unit 102 is used to connect external devices (not shown) such as a portable computer, for transmitting data between connected external devices and the electronic device 100.

The encrypting/decrypting unit 104 is connected to the interface unit 102 and the storage unit 110. The storage unit 110 is configured for storing a unique code that is used for data encryption and data decryption. The unique code is bound to the electronic device 100, that is, each electronic device is associated with an exclusive unique code. For example, the unique code may be a barcode, a manufacturer serial number, or a main chip identification of the electronic device 100.

The encrypting/decrypting unit 104 is configured for generating a special key using the unique code and encrypting or decrypting the data with the special key. The special key may also be generated by combining the unique code with a predetermined password. For example, the electronic device 100 is a mobile phone configured with a keypad. The mobile phone has an International Mobile Equipment Identity (IMEI) number stored in a read only memory (ROM) of the mobile phone. When a document is to be stored in the flash memory card 30, a special key is generated by combining the IMEI number and the predetermined password inputted using the keypad. The document is then encrypted using the special key and stored in the flash memory card 30, thereby yielding an encrypted document. The flash memory card 30 may be entirely stolen and inserted into a second mobile phone. However, because the IMEI number of the second mobile phone is different from that of the original mobile phone, and furthermore, the predetermined password is not known to others, the second mobile phone is not able to correctly generate the special key. Therefore, the document is prevented from being decrypted by other mobile phones even if the flash memory card 30 is entirely stolen.

The encoding/decoding unit 106 is connected to the encrypting/decrypting unit 104 and the reading/writing unit 108. The encoding/decoding unit 106 is configured for encoding the encrypted data, and transmitting encoded data to the reading/writing unit 108. The encoding/decoding unit 106 is also configured for decoding data transmitted from the reading/writing unit 108 and transmitting decoded data to the encrypting/decrypting unit 104.

The reading/writing unit 108 is configured for reading the encoded data stored in the data storage medium 10 and writing the encoded data into the data storage medium 10. For example, the reading/writing unit 108 writes encoded data into the optical disc 20 by irradiating laser beams modulated by the encoded data to the optical disc 20. The reading/writing unit 108 also writes marked data to the data storage medium 10 for indicating whether the encoded data has been encrypted or not. In another example, the reading/writing unit 108 may receive reflected laser beams from the optical disc 20 and converting optical signals to electrical signals from the reflected laser beams. Thereby, the encoded data stored in the optical disc 20 is read out.

As described above, unique code such as the barcode of the electronic device 100 is used to generate the special key for encrypting data to be stored in the data storage medium 10. Because the unique code or the special key is stored in the corresponding storage unit 110 of the electronic device 100, other electronic devices having different unique code would not be able to generate the special key for decrypting the encrypted data. Therefore, the data stored in the data storage medium 10 is effectively prevented from being maliciously reproduced.

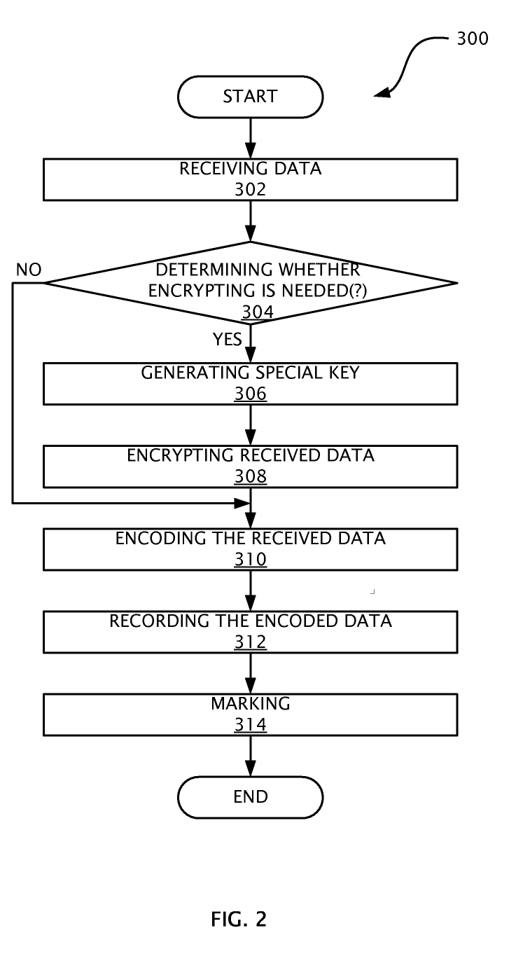

Referring to FIG. 2, a method 300 for data encryption is illustrated. In some embodiments, the method 300, or portions thereof, may be performed by the electronic device 100 as described above. The various actions in the method 300 may be performed in the order presented, or may be performed in a different order. Furthermore, in some embodiments, some actions listed in FIG. 2 may be omitted from the method 300.

At block 302, receiving data that are to be stored in a data storage medium is performed. For example, the interface unit 102 receives data that are to be stored in the data storage medium 10.

At block 304, determining whether the received data needs to be encrypted is performed. If the received data need to be encrypted, the procedure goes to block 306. If the received data need not to be encrypted, the procedure goes to block 310.

At block 306, generating special key that is used for data encryption is performed. If the received data include a predetermined password, the special key is generated by combining the predetermined password and the unique code. The unique code may be a barcode, a manufacturer serial number, or a main chip identification of the electronic device 100. Because different electronic devices have different unique code such as the manufacturer serial number, so that the special key is different accordingly.

At block 308, encrypting the received data is performed. For example, the encrypting/decrypting unit 104 encrypts the data that are transmitted from the interface unit 102. Various encrypting algorithms such as BlowFish and MD5 may be employed for encrypting the data.

At block 310, encoding the encrypted data is performed. For example, the encoding/decoding unit 106 encodes the data with Eight-to-fourteen Modulation plus (EFMplus) that is suitable for an optical disc 20.

At block 312, storing the encoded data to the data storage medium is performed. For example, the reading/writing unit 108 writes the encoded data to an optical disc 20 (see FIG. 1) by irradiating laser beams modulated by the encoded data to the optical disc 20.

At block 314, marking the data storage medium is performed. The marked data is used for indicating if the data stored in the data storage medium is encrypted or not. For example, the data storage medium may be an optical disc 20 as shown in FIG. 1. The marked data are written into the last sixteen bytes of each Error Correction Code (ECC) of an Inner Disc Identification Zone (IDIZ) of DVD+R/RW.

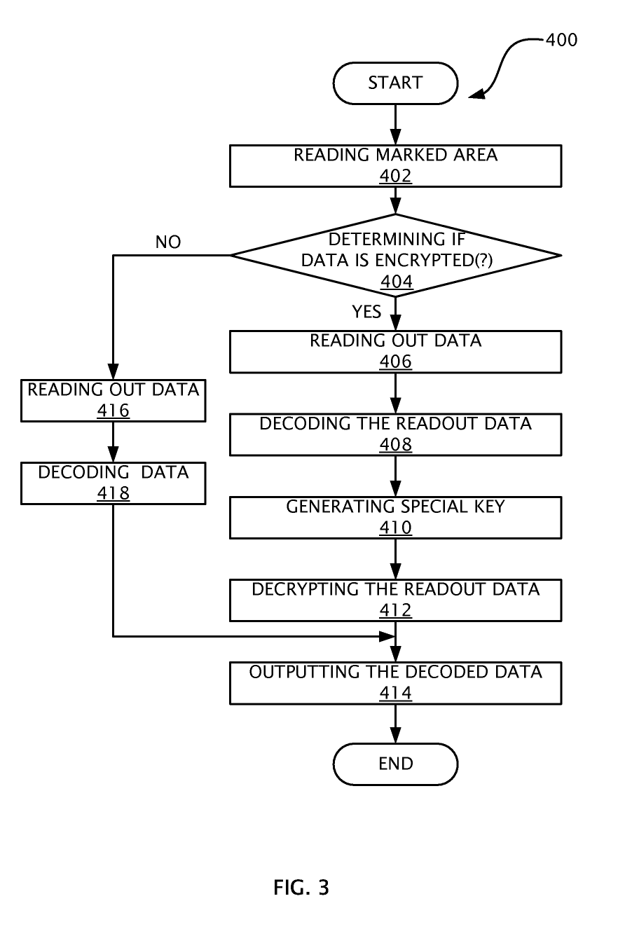

Referring to FIG. 3, a method 400 for data decryption is illustrated. In some embodiments, the method 400, or portions thereof, may be performed by the electronic device 100 as described above. The various actions in the method 400 may be performed in the order presented, or may be performed in a different order. Furthermore, in some embodiments, some actions listed in FIG. 3 may be omitted from the method 400.

At block 402, reading the marked data that are used for indicating if the stored data have been encrypted is performed. For example, the marked data stored in the data storage medium are read by the reading/writing unit 108.

At block 404, determining whether the data stored in the data storage medium has been encrypted or not encrypted according to the marked data is performed.

At block 406, if the data have been encrypted, reading the data stored in the data storage medium is performed.

At block 408, decoding the data that are read from the data storage medium is performed. For example, the encoding/decoding unit 106 decodes the data transmitted from the reading/writing unit 108.

At block 410, generating a special key from the unique code is performed. For example, the special key is generated from a manufacturer serial number, or a barcode of the unique code. The special key may also be generated by combining the unique code with a predetermined password.

At block 412, decrypting the decoded data using the special key is performed. For example, the encrypting/decrypting unit 104 decrypts the decoded data by BlowFish or MD5, as appropriate.

At block 414, outputting the decrypted data is performed. For example, the decrypted data is outputted from the interface unit 102 to the external devices such as the portable computer.

At block 416, if the data has not been encrypted, reading data from the data storage medium is performed.

At block 418, decoding the data that are read from the data storage medium is performed. After the data are decoded, the procedure goes to block 414, where the decoded data are outputted.

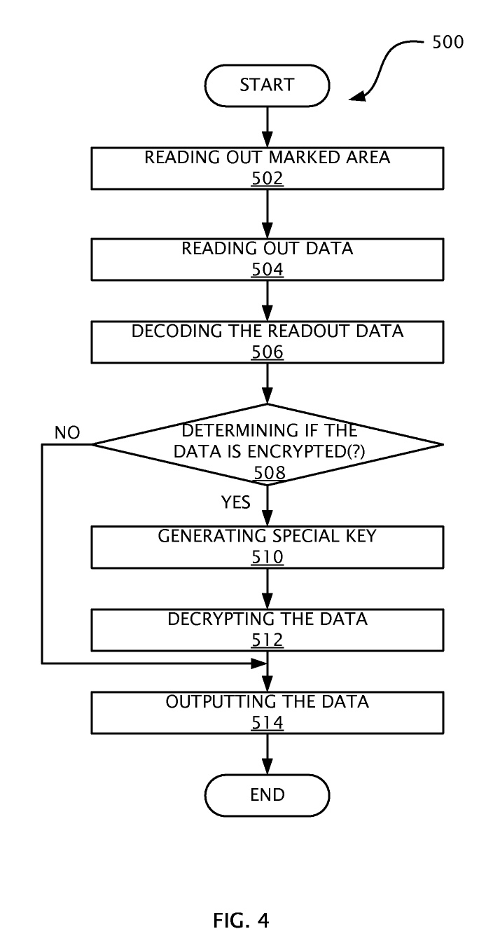

Referring to FIG. 4, another method 500 for data decryption is illustrated. In some embodiments, the method 500, or portions thereof, may be performed by the electronic device 100 as described above. The various actions in the method 500 may be performed in the order presented, or may be performed in a different order. Further, in some embodiments, some actions listed in FIG. 4 may be omitted from the method 500.

At block 502, reading marked data from the data storage medium is performed. The marked data is used for indicating if the data stored in the data storage medium have been encrypted or not.

At block 504, reading data stored in the data storage medium is performed. For example, the reading/writing unit 108 receives reflected laser beams from the data storage medium and converts optical signals to electrical signals that can be recognized by the electronic device 100.

At block 506, decoding the data that are read from the data storage medium is performed. For example, the encoding/decoding unit 106 decodes the data transmitted from the reading/writing unit 108.

At block 508, determining whether the decoded data is encrypted according to the marked data is performed.

At block 514, if the data stored in the data storage medium are not encrypted, outputting the decoded data is performed.

At block 510, generating a special key from the unique code is performed. For example, the special key is generated from a manufacturer serial number, or a barcode of the unique code. The special key may also be generated by combining the unique code with the predetermined password.

At block 512, decrypting the decoded data using the special key is performed. For example, the encrypting/decrypting unit 104 decrypts the decoded data by BlowFish or MD5.

At block 514, outputting the decrypted data is performed. For example, the decrypted data are outputted from the interface unit 102 to connected external devices such as the portable computer.

As described above, the method of data encryption encrypts data with a special key generated from unique code such as a barcode of the corresponding electronic device. The method of data decrypting decrypts data with the special key accordingly. Because the unique code is stored in the electronic device, other electronic devices having different special keys cannot read out the data stored in the data storage medium. Therefore, the data are effectively prevented from maliciously reproduced.

Alternative embodiments will become apparent to those skilled in the art to which the present invention pertains without departing from the spirit and scope, and the invention be protected by the accompanying claims.

What is claimed is:

1. An electronic device for encrypting data that are to be stored in a data storage medium or for decrypting data reproduced from the data storage medium, the electronic device comprising:
an interface unit for receiving data that are to be stored in the data storage medium and outputting data read from the data storage medium to external devices;
a storage unit for storing unique code corresponding to the electronic device, the unique code used for generating a special key for data encryption; and
an encrypting/decrypting unit coupled to the interface unit and the storage unit, the encrypting/decrypting unit receiving the data transmitted from the interface unit and the unique code transmitted from the storage unit for generating the special key, and encrypting the data with the special key or decrypting the data transmitted from the data storage medium with the special key.

2. The electronic device of claim 1, further comprising:
an encoding/decoding unit coupled between the encrypting/decrypting unit and the data storage medium for encoding data encrypted by the encrypting/decrypting unit or decoding the data that are read from the data storage medium.

3. The electronic device of claim 1, wherein the unique code is a manufacturer serial number of the corresponding electronic device, and the manufacturer serial number is stored in the storage unit.

4. The electronic device of claim 1, wherein the unique code is a barcode of the corresponding electronic device, and the barcode is stored in the storage unit.

5. The electronic device of claim 1, wherein unique code is a main chip identification of the electronic device, and the main chip identification is stored in the storage unit.

6. The electronic device of claim 1, wherein the special key is generated by combining the unique code with a predetermined password.

7. The electronic device of claim 1, wherein the electronic device writes marked data to the data storage medium for indicating if the data stored in the data storage medium is encrypted.

8. A method for encrypting data to be stored in a data storage medium, the method comprising:
receiving the data;
generating a special key from a unique code associated with a corresponding electronic device;
encrypting the data with the special key; and
storing the data encrypted with the special key to the data storage medium.

9. The method of claim 8, further comprising:
encoding the data encrypted with the special key before the data are stored in the data storage medium.

10. The method of claim 8, further comprising:
writing marked data to the data storage medium for indicating if the data stored in the data storage medium are encrypted.

11. The method of claim 8, wherein generating the special key from the unique code comprises:
combining the unique code with a predetermined password for generating the special key.

12. The method of claim 8, wherein the unique code is a manufacturer serial number associated with the corresponding electronic device.

13. The method of claim 8, wherein the unique code is a barcode associated with the corresponding electronic device.

14. The method of claim 8, wherein the unique code is a main chip identification associated with the corresponding electronic device.

15. A method for decrypting data reproduced from a data storage medium, the method comprising:
reading the data stored in the data storage medium;
determining whether the data is encrypted or not;
generating a special key from a unique code associated with and stored in an electronic device if the data are encrypted;
decrypting the data with the special key; and
outputting the decrypted data.

16. The method of claim 15, wherein generating special key from preformed data comprising:
combining the unique code with a predetermined password.

17. The method of claim 15 further comprising:
reading marked data from the data storage medium, the marked data for indicating if the data stored in the data storage medium are encrypted.

18. The method of claim 15, wherein the unique code is a manufacturer serial number associated with the corresponding electronic device.

19. The method of claim 15, wherein the unique code is a barcode associated with the corresponding electronic device.

20. The method of claim 15, wherein the unique code is a main chip identification associated with the corresponding electronic device.
